(19) United States
(12) Patent Application Publication
(10) Pub. No.: US 2023/0018265 A1
(43) Pub. Date: Jan. 19, 2023

(54) SYSTEM AND METHOD FOR USER INTERFACE MANAGEMENT FOR CAPACITY-DRIVEN SCHEDULING

(71) Applicant: Seth Feuerstein, New Haven, CT (US)

(72) Inventor: Seth Feuerstein, New Haven, CT (US)

(21) Appl. No.: 17/863,895

(22) Filed: Jul. 13, 2022

Related U.S. Application Data
(60) Provisional application No. 63/221,139, filed on Jul. 13, 2021.

(51) Int. Cl. G06Q 10/10; G06Q 30/06; G06Q 40/08

(52) U.S. Cl. CPC G06Q 10/1095; G06Q 30/0611; G06Q 30/0641; G06Q 40/08

(57) ABSTRACT

A computerized system and method for providing a user interface and system for managing scheduling of tasks on a capacity-driven basis that improves the efficiency of use of limited resources, and can reverse the typical balance of power and negotiation leverage, for example, in medical/healthcare provider and patient/consumer transactions. Providers can determine pricing, but Consumers can be notified of changes in capacity (e.g., due to appointment cancellations) that favor the patient/consumer, and present an opportunity for discounted pricing, while also allowing the provider to avoid a lost revenue opportunity. The system is structured to serve multiple unaffiliated providers, so that consumer demand and provider capacity may be matched across multiple providers, which is atypical in particular for medical/healthcare providers. This provides an increased opportunity for discounted services to the consumer/patient, and provides increased revenue opportunities across the multiple providers as lost revenue opportunities are decreased.

### CROSS-REFERENCE TO RELATED APPLICATION

This application claims the benefit of priority of U.S. Provisional Patent Application No. 63/221,139, filed Jul. 13, 2021, the entire disclosure of which is hereby incorporated herein by reference.

### FIELD OF THE INVENTION

The present invention relates generally to management of variations in demand and/or available resources, and more specifically, to a computerized system and method for providing a user interface and system for managing scheduling of tasks on a capacity-driven basis.

### DISCUSSION OF RELATED ART

There are many instances and contexts in which there is variability in demand and/or available resources. As a result, there is a corresponding variability in capacity for accommodating new/added demand. A common concern is underutilization of excess capacity, particularly when the relevant resource is, or is related to, available time, since time lost cannot be recaptured. Unused or underused capacity generally results in underutilization and decreased, or sub-optimal, yields, which is undesirable.

Although there are examples in many fields, one such example relates to scheduling of appointments for providers of professional and/or healthcare services. For example, treating physicians often schedule appointments with patients in a tightly-packed arrangement of timeslots with minimal timeslot vacancies. This tends to support a high-efficiency of utilization of the physician's time, which generally tends to support relatively higher medical practice revenue.

Often, there is substantial demand for the physician's services, and thus the physician's time is the limited resource of main concern in this context. Accordingly, physician's generally dictate the scheduling of appointments (to conform to the physician's desired schedule), and in the context of procedures not subject to insurance-contract mandates, the pricing for services. The pricing in this context, particularly for discretionary services, is often premium-level pricing, as the transactional leverage in the physician/patient relationship typically resides mainly with the physician. This may be adequate, and possibly advantageous, from the perspective of medical care quality.

What is needed is a system and method providing a user interface and system for managing scheduling of tasks on a capacity-driven basis. In this manner, the efficiency of use of limited resources may be improved.

### SUMMARY

The present invention provides a computerized system and method for providing a user interface and system for managing scheduling of tasks on a capacity-driven basis. Thus, the present invention provides a system that improves the efficiency of use of limited resources. Further, the system effectively reverses the typical balance of power and negotiation leverage, for example, in medical/healthcare provider and patient/consumer transactions.

More particularly, it allows the provider the freedom to determine pricing, and perhaps apply premium pricing in a typical appointment-based scheduling scenarios, but also notifies patients/consumers of changes in capacity (e.g., due to appointment cancellations) that favor the patient/consumer, and present an opportunity for discounted pricing, while also allowing the provider to avoid a lost revenue opportunity. For example, a Consumer/Patient's offer to pay $100 for a procedure typically costing $300 may be an attractive offer to the Provider, since otherwise, the newly-available capacity (resulting from an appointment cancellation) may be lost as no substitute appointment may be scheduled on short notice, and thus, the value of that capacity may otherwise by $0, making $100 an attractive alternative, even though less than the typical $300. This information may be stored as Payment Data 224f in the Data Store 224 of the CDSS 200, e.g., as an “offer.” Notable, the system is structured as a system serving multiple providers, so that consumer demand and provider capacity may be matched across multiple providers, which is atypical in particular for medical/healthcare providers. This provides an increased opportunity for discounted services to the consumer/patient, and provides increased revenue opportunities across the multiple providers as lost revenue opportunities are decreased.

### BRIEF DESCRIPTION OF THE FIGURES

For a better understanding of the present invention, reference may be made to the accompanying drawings in which:

FIG. 1 is a system diagram showing an exemplary network computing environment in which the present invention may be employed; and

FIG. 2 is a schematic diagram of an exemplary special-purpose Capacity-Driven Scheduling System computing device in accordance with an exemplary embodiment of the present invention;

FIGS. 3A and 3B show a flow diagram illustrating a method for user interface management for a capacity-based appointment scheduling system in accordance with an exemplary embodiment of the present invention; and

FIGS. 4-12 illustrate exemplary graphical user interface windows displayable by the exemplary special-purpose Capacity-Drive Scheduling System computing device in accordance with an exemplary embodiment of the present invention.

### DETAILED DESCRIPTION

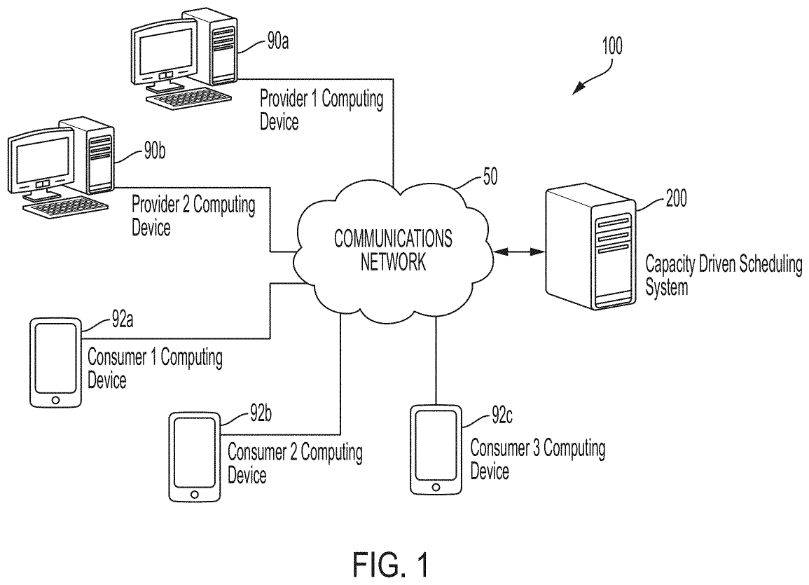

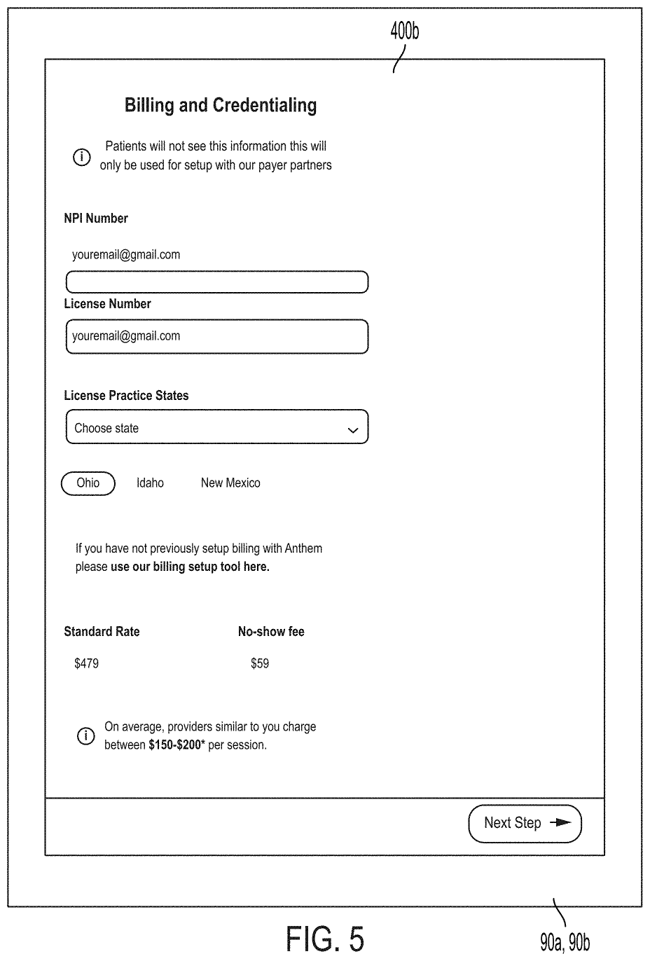

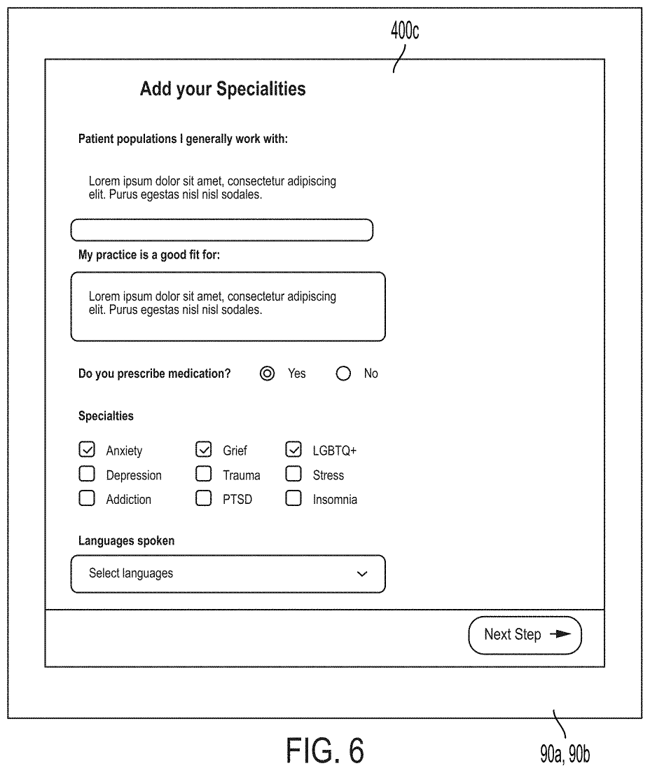

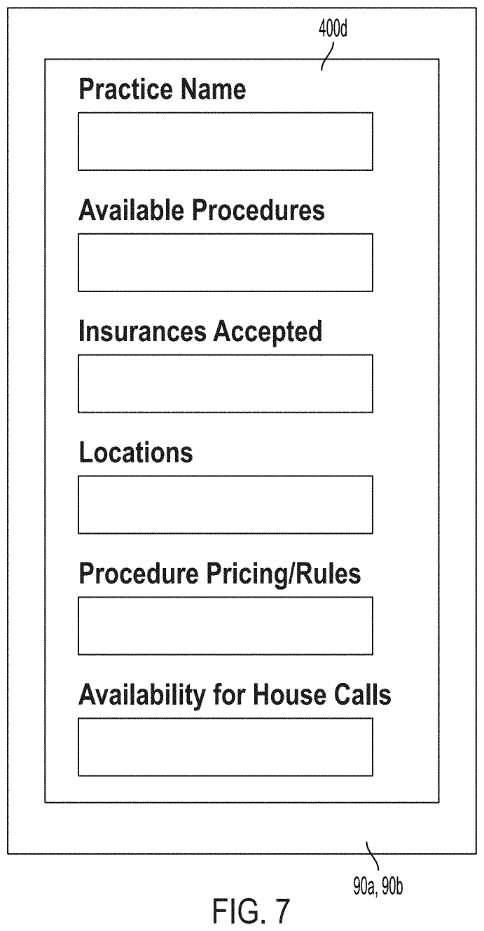

According to illustrative embodiment(s) of the present invention, various views are illustrated in FIGS. 1-12 and like reference numerals are used consistently throughout to refer to like and corresponding parts of the invention for all of the various views and Figures of the drawings.

The following detailed description of the invention contains many specifics for the purpose of illustration. Any one of ordinary skill in the art will appreciate that many variations and alterations to the following details are within scope of the invention. Accordingly, the following implementations of the invention are set forth without any loss of generality to, and without imposing limitations upon, the claimed invention.

The present invention provides a system and method for developing a trusted peer support network for supporting and intervening to avert adverse outcomes for members of at-risk populations, and for educating, training, and/or supporting members of the peer network.

### System Environment

An exemplary embodiment of the present invention is discussed below for illustrative purposes. FIG. 1 is a system diagram showing an exemplary network computing environment 100 in which the present invention may be employed. As shown in FIG. 1, the exemplary network environment 100 includes conventional computing hardware and software for communicating via a communications network 50, such as the Internet, etc., using Provider Computing Devices 90a, 90b, and/or Consumer Computing Devices 92a, 92b, and 92c, each of which may be, for example, one or more personal computers/PCs, laptop computers, tablet computers, smartphones, or other computing device hardware.

In accordance with a certain aspect of the present invention, one or more of the Provider Computing Devices 90a, 90b, and/or the Consumer Computing Devices 92a, 92b, 92c may store and execute an “app” or other purpose-specific application software in accordance with the present invention, although this is not required in all embodiments.

In accordance with the present invention, the network computing environment 100 further includes the Capacity Driven Scheduling System (CDSS) 200. In this exemplary embodiment, the CDSS 200 is operatively connected to the Provider Computing Devices 90a, 90b and the Consumer Computing Devices 92a, 92b, 92c for data communication via the communications network 50. For example, the CDSS 200 may gather user data or other inputs from each device 90a, 90b, 92a, 92b, and 92c by data communication via the communications network 50. Hardware and software for enabling communication of data by such devices via such communications networks are well known in the art and beyond the scope of the present invention, and thus are not discussed in detail herein.

By way of example, the present invention may be used in the context of schedule appointments for medical/healthcare services provided by medical/healthcare providers to patients/consumers. Accordingly, in the example of scheduling of appointments for medical/healthcare services, Provider Computer Devices 90a, 90b may be operated by medical/healthcare service providers, and the Consumer Computing Devices 92a, 92b, 92c may be operated by patients or other consumers of medical/healthcare services.

After registration with CDSS 200, a Provider or a Patient may communicate with the CDSS 200 via the Provider and Consumer Devices, and similarly, the CDSS 200 may communicate with the Providers and Patients via the Provider and Consumer Devices.

In certain embodiments, a Provider may use the Provider Device to manage Provider resources, such as appointment/procedure capacity, by scheduling one or more patients for appointments with the provider, to fill the provider's schedule as desired. This may be performed and managed in a generally conventional fashion e.g., by assigning appointment times and places to various providers (e.g., physicians) at specific date/time slots. By way of example, an appointment may be made by calling a provider's office, and having a clerk enter appointment data into the Provider Device. Alternatively, appointments may be made by electronic communication, e.g., using the Consumer Computing Device. Such appointment information may be maintained locally on a Provider Computing Device, or a local computer/server at a physician's office. In such an embodiment, the capacity-driven scheduling functionality described herein may be performed and/or managed at the Patient Computing device.

Preferably, the scheduling information may be communicated from the Provider Computing Device to the CDSS 200 and is managed by the CDSS 200 for the capacity-driven scheduling purposes described herein. Additionally, it is preferable that multiple providers' appointment/scheduling information is communicated to the CDSS 200 for the capacity-driven scheduling purposes described herein.

### Capacity-Driven Scheduling System

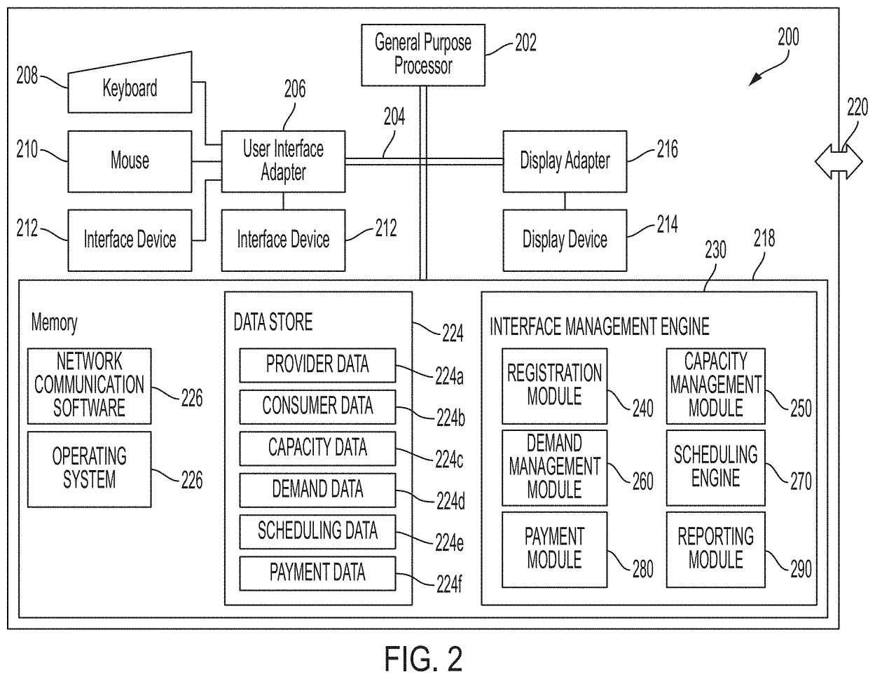

FIG. 2 is a block diagram showing an exemplary Capacity Driven Scheduling System (CDSS) 200 in accordance with an exemplary embodiment of the present invention. The CDSS 200 is a special-purpose computer system that includes conventional computing hardware storing and executing both conventional software enabling operation of a general purpose computing system, such as operating system software 222, network communications software 226, and specially-configured computer software for Configuring the general purpose hardware as a special-purpose computer system for carrying out at least one method in accordance with the present invention. By way of example, the communications software 226 may include conventional web server software, and the operating system software 22 may include iOS, Android, Windows, Linux software.

Accordingly, the exemplary CDSS 200 of FIG. 2 includes a general-purpose processor, such as a microprocessor (CPU), 102 and a bus 204 employed to connect and enable communication between the processor 202 and the components of the presentation system in accordance with known techniques. The exemplary presentation system 200 includes a user interface adapter 206, which connects the processor 202 via the bus 204 to one or more interface devices, such as a keyboard 208, mouse 210, and/or other interface devices 212, which can be any user interface device, such as a camera, microphone, touch sensitive screen, digitized entry pad, etc. The bus 204 also connects a display device 214, such as an LCD screen or monitor, to the processor 202 via a display adapter 216. The bus 204 also connects the processor 202 to memory 218, which can include a hard drive, diskette drive, tape drive, etc.

The CDSS 200 may communicate with other computers or networks of computers, for example via a communications channel, network card or modem 220. The CDSS 200 may be associated with such other computers in a local area network (LAN) or a wide area network (WAN), and may operate as a server in a client/server arrangement with another computer, etc. Such Configurations, as well as the appropriate communications hardware and software, are known in the art.

The CDSS 200 is specially-configured in accordance with the present invention. Accordingly, as shown in FIG. 2, the CDSS 200 includes computer-readable, processor-executable instructions stored in the memory 218 for carrying out the methods described herein. Further, the memory 218 stores certain data, e.g. in one or more databases or other data stores 224 shown logically in FIG. 2 for illustrative purposes, without regard to any particular embodiment in one or more hardware or software components.

Further, as will be noted from FIG. 2, the CDSS 200 includes, in accordance with the present invention, an Interface Management Engine Module (IME) 230, shown schematically as stored in the memory 218, which includes a number of additional modules providing functionality in accordance with the present invention, as discussed in greater detail below. These modules may be implemented primarily by specially-configured software including microprocessor—executable instructions stored in the memory 218 of the CDSS 200. Optionally, other software may be stored in the memory 218 and and/or other data may be stored in the data store 224 or memory 218.

As shown in FIG. 2, the exemplary embodiment of the CDSS 200 also includes a Registration Module (RM) 240. The RM 240 is responsible for sending data to cause display of graphical user interface windows at a Provider Computing Device 90a, 90b for gathering Provider user account information, and for transmitting data via the network to cause display of graphical user interface windows at a Consumer Computing Device 92a, 92b for gathering Consumer user account information, and for receiving/gathering such information and causing it to be stored in the data store 224 of the CDSS 200 as Provider Data 224a and Patient Data 224b, respectively. For example, the RM 240 may cause display of graphical user interface windows requiring a Provider to provide the following information as part of registration to create a user account for the provider: practice name, practice location/address, practice contact information, physicians, specialties, available procedures, insurances accepted, procedure pricing, availability for house calls. By way of example, this resource profile information may be gathered by the CDSS 200 by way of a graphical user interface window during creation of a physician/provider profile using the provider's smartphone, tablet, PC or other computing device to interact with the CDSS 200 via the network in an online data communications session.

By way of further example, the RM 240 may cause display of graphical user interface windows requiring a Consumer to provide the following information as part of registration to create a user account for the provider: name, location/address, contact information, preferred physicians, preferred specialties, preferred procedures, insurance, house call preference, e.g., during creation of a patient/consumer profile using the patient/consumer's smartphone, tablet, PC or other computing device to interact with the CDSS 200 via the network in an online data communications session. Notably, this Consumer user account information includes not only basic identity and contact information but also, in accordance with the present invention, includes additional demand profile information that may be useful in performing the capacity-driven scheduling functionality described herein.

In accordance with the present invention, the exemplary embodiment of the CDSS 200 shown in FIG. 2 also includes a Capacity Management Module (CMM) 250. The CMM 250 is responsible for transmitting data via the network 50 to cause display of graphical user interface windows at a Provider Computing Device 90a, 90b for gathering resource availability and/or capacity (collectively “capacity”) information. Capacity data may be received and stored by the CMM 250 as Capacity Data 224c. More particularly, in accordance with the present invention, the CMM 250 is responsible for keeping track of/monitoring information relating to available capacity of resources and/or resource providers. Accordingly, for example, the CMM 250 may be used to determine a physician's availability, in support of scheduling appointments according to that physician's availability.

In accordance with the present invention, the exemplary embodiment of the CDSS 200 shown in FIG. 2 also includes a Demand Management Module (DMM) 260. The DMM 260 is responsible for transmitting data via the network 50 to cause display of graphical user interface windows at one or more Consumer Computing Device 90a, 90b for gathering information identifying resources/tasks/procedures desired by each Consumer. Such information may be received and stored by the DMM 260 as Demand Data 224d. Such Demand Data may be very fluid and dynamic and change frequently over time as the Consumer updates its needs (e.g., via the Demand Management Module), or it may be relatively static as somewhat of a “standing order”. For example, the Demand Data may indicate that a Consumer generally wants Botox injections, and wishes to be notified of available capacity whenever such capacity becomes available.

More particularly, in accordance with the present invention, the DMM 260 is responsible for gathering information about the consumer's desired resources that may be matched with appropriate capacity. Accordingly, for example, the DMM 260 may be used to determine a consumer's desires, in support of scheduling appointments/procedures according to that consumer's desires. Notably, the DMM 260 may gather information such as location, insurances accepted, procedures, preferred physicians, preferred practices, etc., and this information may indicate needs/preferences that span across more than one practice or organization. Accordingly, the DMM 260 is effectively identifying current Consumer need information. Consumer need data may be received and stored by the DMM 260 as Consumer Data 224d.

In accordance with the present invention, the exemplary embodiment of the CDSS 200 shown in FIG. 2 also includes a Scheduling Engine (SE) 270. The SE 270 is responsible for monitoring for increased (and likely an unexpected increase) in capacity. In this example, such an increase in capacity may occur as the result of a last-minute cancellation of a previously-scheduled appointment with a particular physician. The SE 270 may monitor for such increases and/or change in capacity not only for a single resource such as a physician or medical practice, but rather across multiple physicians or medical practices in a way that is not conventional. For example, a single doctor's office may have scheduling software for scheduling appointments for a physician or organization of physicians in a single practice or organization. However, the SE 270, as part of a CDSS 200 serving multiple discrete/distinct medical practices/organizations can look across multiple such organizations to identify capacity not only within a single practice/organization, but in any registered practice/organization, which supports the capacity-driven scheduling functionality described herein. Accordingly, the SE 270 is effectively identifying unused, or likely to be unused or wasted capacity resources.

When the SE 270 identifies a particular unit of increased capacity, or at other times, it may retrieve information from the Provider Data 224a that may be used to identify the nature of the capacity in support of the capacity-driven scheduling functionality described herein. For example, the SE 270 may identify increased capacity of one hour for a particular physician. The SE 270 may then retrieve information from the Provider Data 224a to identify that physician's medical specialty, procedures that the physician can perform, location information, pricing information, insurance information, and/or any other information that may be useful in matching appropriate demand with this identified 1 hour of capacity.

Further, the SE 270 may then retrieve information from the Consumer Data 224d to identify any particular consumers having needs, as reflected in the Demand Data 224d that matches/corresponds to or potentially matches/corresponds to the newly-identified capacity. For example, a Consumer seeking a Botox injection may be identified in response to an available hour of physician time for a Botox injection, or in response to an available hour of a dermatologist's time (that is known to the system as a provider of a Botox injection procedure).

There may be additional parameters that are tracked by the system and used to determine matches/potential matches. For example, not only medical practice and physician specialty, but also medical procedure may be matched as well as location, proximity to the particular consumer, availability (e.g., certain days, timeframes, or with limited notice, etc.). Any suitable parameters may be gathered and tracked by the system and used for this matching purpose, as will be appreciated by those skilled in the art.

When a match or potential match is identified by the SE 270, then the SE 270 transmits data via the network 50 to cause display of appropriate graphical user interface windows (or other messages) at a Provider Computing Device 90a, 90b and/or a Consumer Computing Device 92a, 92b, 92c indicating the match or potential match of available capacity to that Consumer's needs/desires. For example, the consumer may receive an e-mail or text with a hyperlink to a web page at which the Consumer may review the available capacity, and perhaps make use of it—e.g., by booking an appointment in this example. Similarly, a particular Provider may receive an e-mail, text, or other alert (e.g., pop-up window or other message in a graphical user interface dashboard) indicating that there is demand matching the particular provider's expertise, etc., and provide the Provider with an option to approve/initiate scheduling of a visit/procedure, etc. in accordance with the demand.

In some embodiments, the visit may be automatedly scheduled by the CDSS 200 (e.g., according to availability of the provider, open appointment slots, etc.), and optionally, in accordance with scheduling rules, e.g., scheduling rules provided by the Provider in the Provider's profile/account.

The exemplary embodiment of the CDSS 200 shown in FIG. 2 also includes a Payment Module (PM) 280. The PM 280 is responsible for effectively negotiating a price for the resource. This may be performed by the PM 280 transmitting data via the network 50 to cause display of graphical user interface windows at one or more Consumer Computing Devices 92a, 92b, 92c for gathering a proposed payment/offer for the relevant resource/capacity/procedure. For example, information may be gathered indicating that the Consumer is willing to pay $100 for a procedure that typically costs $300. This may be an attractive offer to the Provider.

In certain embodiments, the PM 280 may transmit data via the network 50 to cause display of graphical user interface windows at one or more Provider Computing Devices 90a, 90b for displaying the proposed offer for the available capacity, and collecting user input via the Provider Computing Device indicating an acceptance or rejection of that offer. In certain embodiments, the PM 280 transmit data via the network 50 to cause display of graphical user interface windows at one or more Provider Computing Devices 92a, 92b and/or Consumer Computing Devices 92a, 92b, 92c to allow for one or more counteroffers and acceptance and/or rejection of same.

In certain other embodiments, the PM 280 may compare the Consumer's offer to pre-established acceptable offers, or discounts, or pricing strategy, or ranges, and/or may provide counteroffers and/or negotiate the pricing in accordance with pre-determined parameters and/or logic, which may be gathered/selected from the Provider (or the Consumer) during the registration process (and be retrieved from the Provider Data 224a and/or the Consumer Data 224b, as appropriate).

The exemplary embodiment of the CDSS 200 shown in FIG. 2 also includes a Reporting Module (RM) 290. Whether accepted or rejected, the Reporting Module (RM) 290 is responsible for transmitting data via the network 50 to cause display of appropriate graphical user interface windows (or other messages), or other data to update scheduling software of the Provider and/or calendar or similar software of the Consumer, to reflect the acceptance or rejection.

If accepted, the PM 280 may transmit data via the network 50 to cause display of appropriate graphical user interface windows (or other messages) at a Consumer Computing Devices 92a, 92b, 92c to complete a relevant payment/invoicing transaction, and the appointment/procedure/allocation of available resources may be updated accordingly by the CMM 250, with corresponding data being stored as Capacity Data 224 in the Data Stored of the CDSS 200.

In certain embodiments, the PM 280 may also manage a payment transaction (e.g., via credit card) and/or invoicing transaction (e.g., to submit insurance claim information to arrange for payment). Suitable hardware and software for managing such a payment/invoicing transaction are well-known in the art and beyond the scope of the present invention, and thus are not discussed in further detail here.

Accordingly, it will be appreciated that the present invention provides a computerized system and method for providing a user interface and system for managing scheduling of tasks on a capacity-driven basis. Thus, the present invention provides a system that improves the efficiency of use of limited resources. Further, the system effectively reverses the typical balance of power and negotiation leverage, for example, in medical/healthcare provider and patient/consumer transactions.

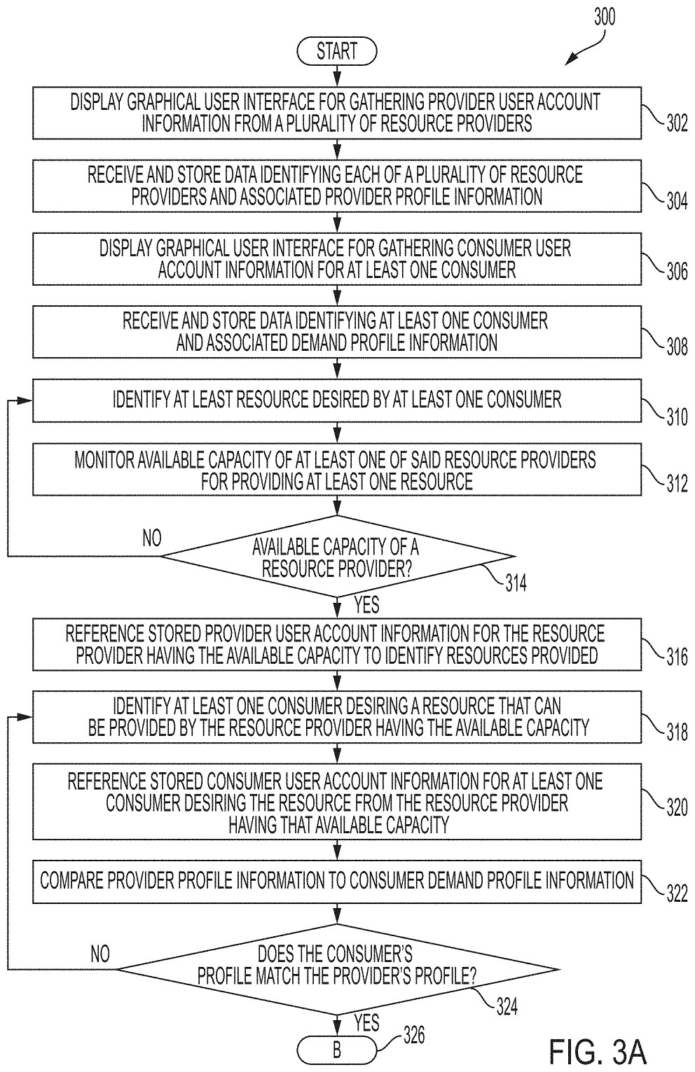

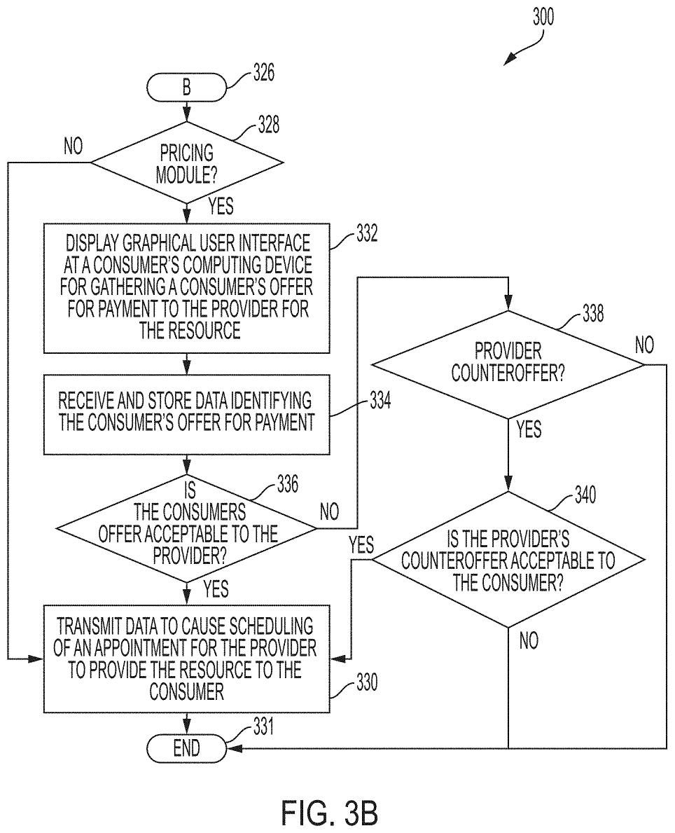

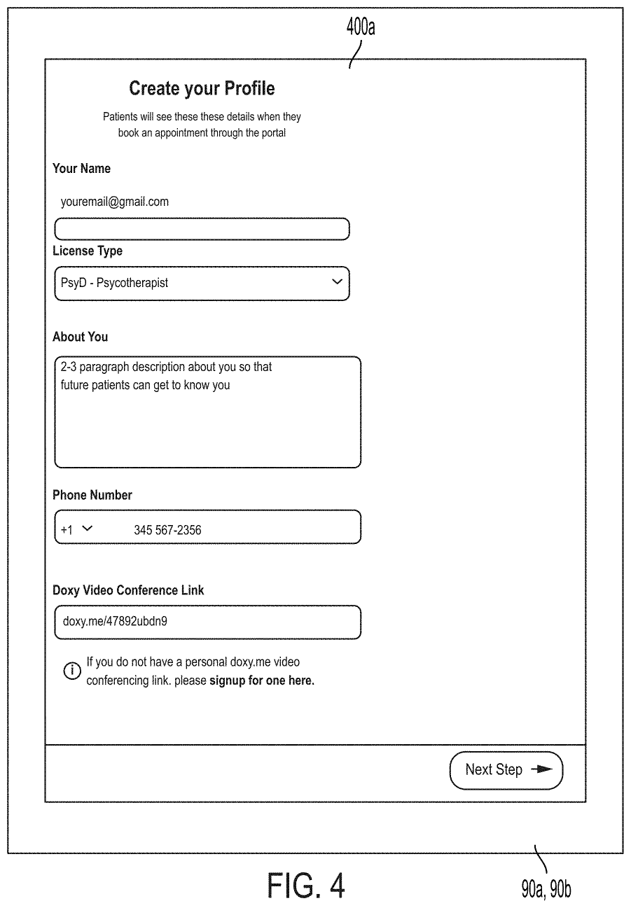

FIGS. 3A and 3B show a flow diagram 300 illustrating an exemplary method involving operation of the CDSS 200 in accordance with an exemplary embodiment of the present invention. The exemplary method begins with providing a CDMSS 200 in accordance with the present invention. Although the illustrated steps need not take place in the order shown, in the exemplary embodiment, the illustrated method begins with display of a graphical user interface for gathering Provider user account information from a plurality of resource providers, as shown at 302 in FIG. 3A. For example, a plurality of physicians may register with the system, by providing certain relevant information, requested by a graphical user interface as described above, as input to a graphical user interface window caused to be displayed by the CDSS 200 on each respective Provider Computing Device 90a, 90b. By way of example, FIGS. 4-7 show exemplary graphical user interface windows 400a, 400b, 400c, 400d that maybe caused to be displayed by the CDSS 200 at a Provider Computing Device 90a, 90b. Exemplary windows 400a, 400b, 400c, 400d are configured to prompt a Provider to provide certain information relevant to establish respective Provider user accounts and relevant to the capacity-driven appointment scheduling that is the subject of the present invention as input to the CDSS 200 via the windows displayed at the Provider Computing Device 90a, 90b. As discussed above by way of non-limiting example, the windows 400a, etc. may prompt the user to provide as input: practice name, practice location/address, practice contact information, physicians, specialties, available procedures, insurances accepted, procedure pricing, availability for house calls, etc. Display of these windows as part of the Provider's registration process may be managed at least in part by the RM 240.

Referring again to FIG. 3A, the CDSS 200 receives and stores data identifying each of a plurality resource providers, and the associated information provided, to create associated provider profiles, as shown at 304 in FIG. 3A. Receipt of such data, and storage of such data as Provider Data 224a in the Data Store 224 stored in the memory 218 of the CDSS 200, as part of Provider's registration process may be managed at least in part by the RM 240, as will be appreciated from FIG. 2.

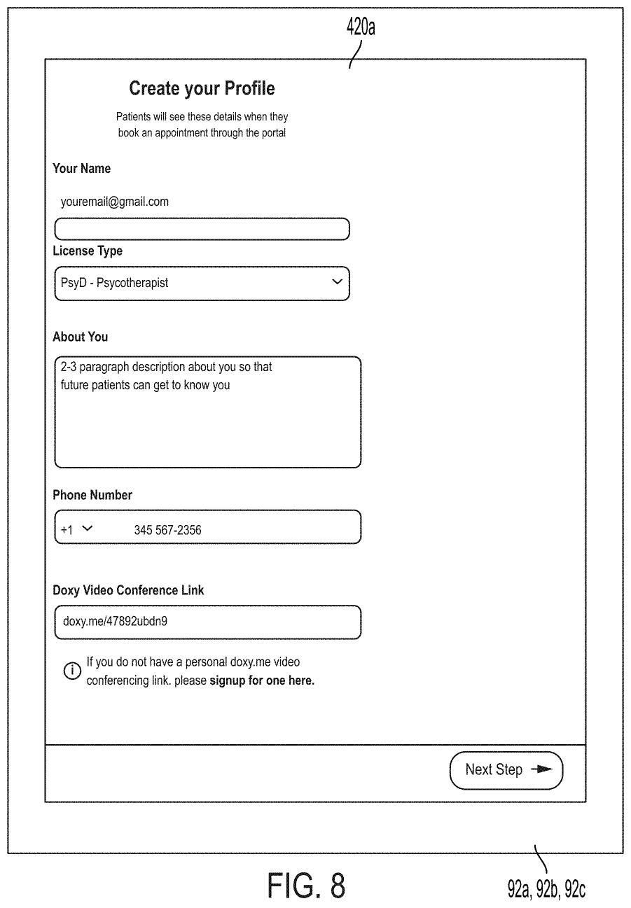

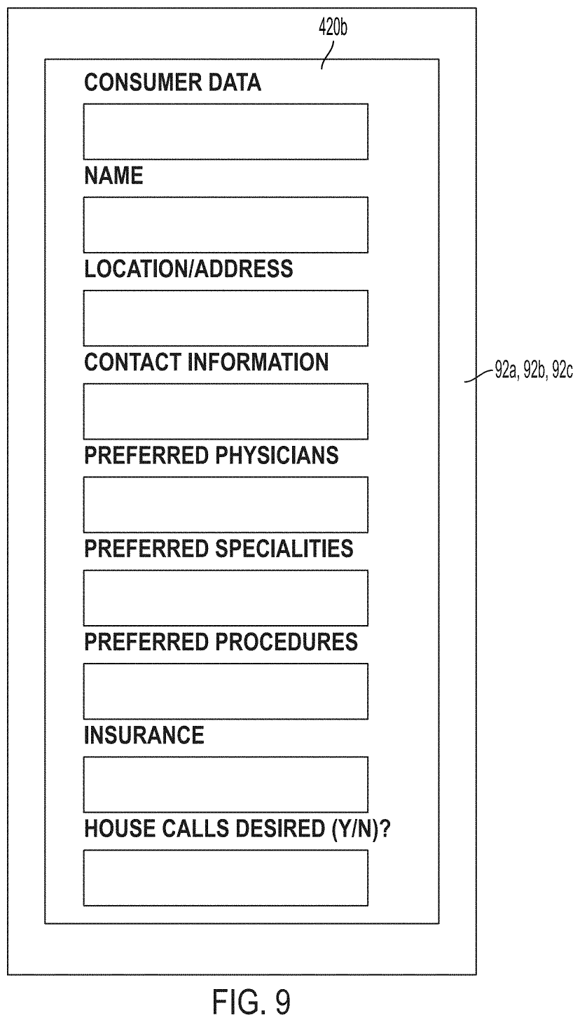

Referring again to FIG. 3A, the exemplary method next involves with display of a graphical user interface for gathering Consumer user account information from a plurality of consumers, as shown at 306. For example, a plurality of patients may register with the system, by providing certain relevant information, requested by a graphical user interface as described above, as input to one or more graphical user interface windows caused to be displayed by the CDSS 200 on each respective Consumer Computing Device 92a, 92b, 92c. By way of example, FIGS. 8-9 show exemplary graphical user interface windows 420a, 420b that may be caused to be displayed by the CDSS 200 at a Consumer Computing Device 92a, 92b, 92c. Exemplary windows 420a, 420b are configured to prompt a Consumer to provide certain information relevant to establish respective Consumer user accounts and relevant to the capacity-driven appointment scheduling that is the subject of the present invention as input to the CDSS 200 via the windows displayed at the Consumer Computing Device 92a, 92b, 92c. As discussed above by way of non-limiting example, the windows 420a, etc. may prompt the user to provide as input: name, location/address, contact information, preferred physicians, preferred specialties, preferred procedures, insurance, house call preference. Display of these windows as part of the Consumer's registration process may be managed at least in part by the RM 240.

Referring again to FIG. 3A, the CDSS 200 receives and stores data identifying each of a plurality consumers, and the associated information provided, to create associated consumer profiles, as shown at 308 in FIG. 3A. Receipt of such data, and storage of such data as Consumer Data 224b in the Data Store 224 stored in the memory 218 of the CDSS 200, as part of Consumer's registration process may be managed at least in part by the RM 240, as will be appreciated from FIG. 2.

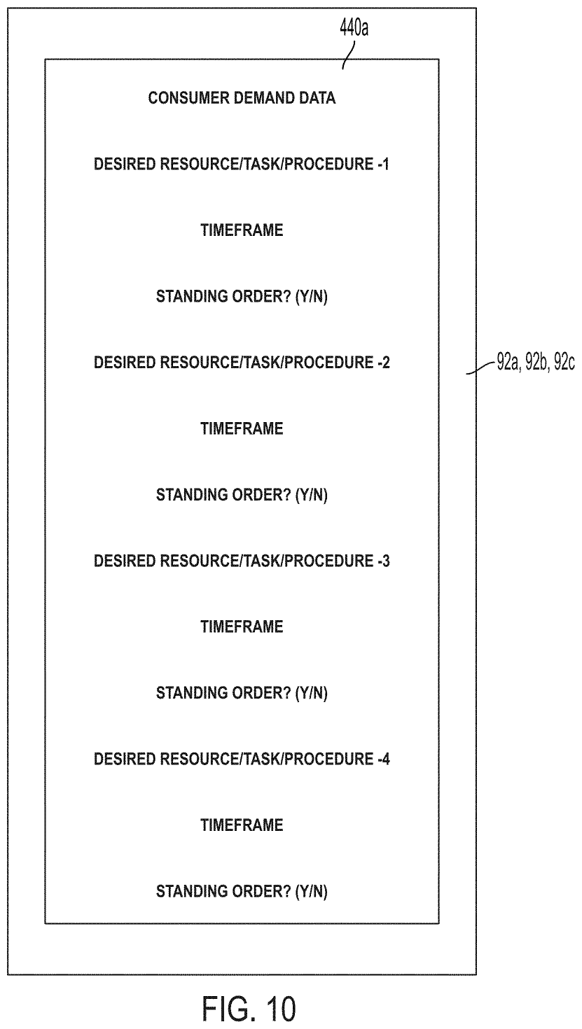

Referring again to FIG. 3A, in this exemplary embodiment, the method next involves identifying at least one resource desired by at least one consumer, as shown at 310. This may be performed by the Demand Management Module (DMM) 260, which may cause the CDSS 200 to transmit data via the network 50 to cause display of graphical user interface windows at one or more Consumer Computing Device 92a, 92b, 92c for gathering information identifying resources/tasks/procedures desired by each Consumer. By way of example, FIG. 10 shows an exemplary graphical user interface windows 440a that may be caused to be displayed by the CDSS 200 at a Consumer Computing Device 92a, 92b, 92c. Exemplary windows 420a, 420b are configured to prompt a Consumer to provide information identifying resource demand and relevant to the capacity-driven appointment scheduling that is the subject of the present invention as input to the CDSS 200 via the windows displayed at the Consumer Computing Device 92a, 92b, 92c. As discussed above by way of non-limiting example, the window 440a may prompt the user to provide as input: the name of a desired resource/task/procedure, the date/timeframe in which that resource is desired, whether the need is a standing order (perpetually until turned off) or a one-time need, etc., as will be appreciated from FIG. 10. Display of these windows may be managed at least in part by the DMM 260.

Such information provided by the Consumer at the Consumer Computing Device 92, 92b, 92c may be received and stored at the CDSS 200 by the DMM 260 as Demand Data 224d. For example, the Demand Data may indicate that a Consumer generally wants Botox injections, and wishes to be notified of available capacity whenever such capacity becomes available.

Referring again to FIG. 3A, in this exemplary embodiment, the method next involves monitoring, e.g. periodically or continuously, the available capacity of at least one of the registered resource providers, as shown at 312. This may be performed by the Capacity Management Module (CMM) 250, which may cause the CDSS 200 to transmit data via the network 50 to cause display of graphical user interface windows at a Provider Computing Device 90a, 90b for gathering resource availability and/or capacity (collectively “capacity”) information. This would allow an operator of the Provider Computing Device 90a, 90b to provide input with a suitable window to identify the available capacity to the CDSS 200. Alternatively, this may be performed by electronic data communication between the CMM 250/CDSS 200 and a scheduling/appointment/calendaring system of the Provider, and suitable information may be exchanged/gathered autonomously, with the need for display of windows and manual input by an operator of the Provider Computing Device 90a, 90b.

Capacity data may be received and stored by the CMM 250 as Capacity Data 224c. Accordingly, in accordance with the present invention, the CMM 250 is responsible for keeping track of/monitoring information relating to available capacity of resources and/or resource providers. Accordingly, for example, the CMM 250 may be used to determine a physician's availability, in support of scheduling appointments according to that physician's availability. For example, the Capacity Data may indicate that a dermatologist Provider has unused/available capacity, for example, for a 30-minute appointment with a patient.

In the exemplary embodiment shown in FIG. 3A, the method next involves determining whether there is available capacity of a resource provider, as shown at 314. This may be performed by the Scheduling Engine 270. Notably, the SE 270 250 may monitor for available capacity on an ongoing basis, such that available capacity resulting from canceled appointment, newly-added provider availability, etc., are promptly identified for scheduling purposes. Additionally, the SE 270 may monitor not only for one or more affiliated providers within a single practice or group, or health system, etc., but across multiple different business entities/offices, provider groups, health systems, etc., including across multiple unaffiliated providers.

If it is determined at 314 that there is no capacity/no new capacity of a resource provider, the in this exemplary method the flow continues to step 310 and 312 to continue to identify resources desired by consumers as may be submitted by consumers, and to monitor for available capacity of a resource provider, both of which may occur asynchronously from time to time.

If it is determined at 314 that there is capacity of a resource provider, then the SE 270/CDSS 200 references stored provider user account information (e.g., Provider Data 224a) for the resource provider having available capacity to identify the particular resources that may be provided by that same resource provider, as shown at 316. For example, it may be determined that a particular dermatologist has capacity, and by reference to the Provider Data, that that particular dermatologist can provide skin examinations and Botox injections (e.g., but not Mohs surgery).

Additionally, the SE 270 may also retrieve additional information from the Provider Data 224a that may be used to identify the nature of the capacity in support of the capacity-driven scheduling functionality described herein. For example, the SE 270 may also retrieve information from the Provider Data 224a to identify the physician's medical specialty, procedures that the physician can perform, location information, pricing information, insurance information, and/or any other information that may be useful in matching appropriate demand with this identified capacity.

Referring again to FIG. 3A, the exemplary method next involves identifying at least one Consumer desiring a resource that can be provided by the Provider having the available capacity, as shown at 318. This may be performed by the SE 270, for example, by referencing stored Demand Data 224d associated with demands of various Consumers.

Referring again to FIG. 3A, the exemplary method next involves referencing stored Consumer Data 224d to identify whether particular consumers having particular resource needs, as reflected in the Demand Data 224d, also have needs/preferences that matches/corresponds to or potentially matches/corresponds to the newly-identified capacity, as shown at 320. For example, a Consumer seeking a Botox injection may be identified in response to an available hour of physician time for a Botox injection, or in response to an available hour of a dermatologist's time (that is known to the system as a provider of a Botox injection procedure).

There may be additional parameters that are tracked by the system and used to determine matches/potential matches. For example, not only medical practice and physician specialty, insurances accepted, etc. but also medical procedure may be matched as well as location, proximity to the particular consumer, availability (e.g., certain days, timeframes, or with limited notice, etc.). Any suitable parameters may be gathered and tracked by the system and used for this matching purpose, as will be appreciated by those skilled in the art.

Referring again to FIG. 3A, the SE 270 then compares the Provider Profile information Consumer Demand Profile information, as shown at 322. The SE 270 then determines whether the consumer's profile (for a consumer desiring a resource that can be provided by the resource provider) matches the provider's profile, as shown at 324. For example, this may involve confirming that that insurances or locations of the provider meet the consumer's needs.

In this exemplary embodiment, if a match is not found at 324, then the flow returns to 318, where another consumer design a resource that can be provided by the provider having the available capacity is considered, in loop fashion.

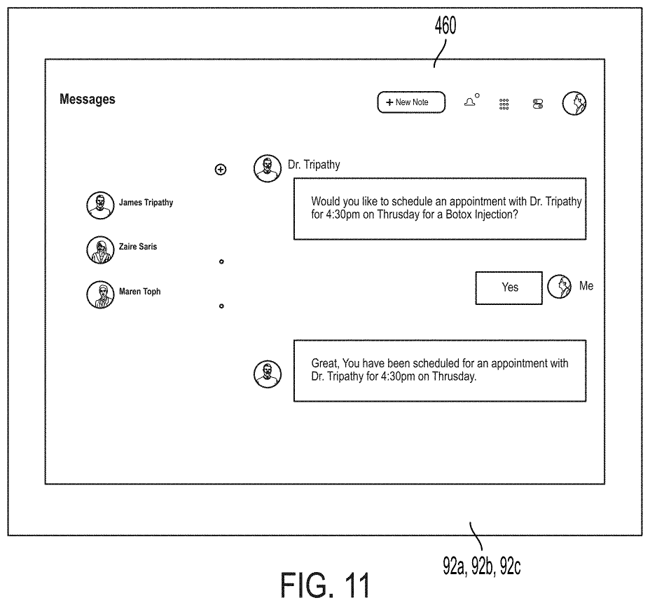

If, however, a match is found at 324, then the flow continues at B 326 to FIG. 3B, where it is determined whether the instance of the CDSS 200 system or the particular resource provider involved uses the system's Pricing Module (a component of the Payment Module 280), as shown at 328. This determination may be made by the Payment Module 280. If not, then method flow continues to 330, and the SE 270 of the CDSS transmits data, e.g., to the Provider Computing Device 90a, 90b and/or the Consumer Computing Device 92a, 92b, 92c, to cause scheduling of an appointment for the Provider to provide the resource to the Consumer. This may involve the SE 270 transmitting data via the network 50 to cause display of appropriate graphical user interface windows (or other messages) at a Provider Computing Device 90a, 90b and/or a Consumer Computing Device 92a, 92b, 92c indicating the match or potential match of available capacity to that Consumer's needs/desires. By way of example, FIG. 11 shows an exemplary graphical user interface window 460 displayable at a Consumer Computing Device 92a, 92b, 92c displaying a text-based interface for scheduling an appointment. Other interfaces, including a calendar-type interface, may be used for this purpose.

As part of 330, the Reporting Module (RM) 290 of the CDSS 200 may transmit data via the network 50 to cause display of appropriate graphical user interface windows (or other messages), or other data to update scheduling software of the Provider and/or calendar or similar software of the Consumer, to reflect the acceptance or rejection. This may also involve interfacing with conventional external appointment, scheduling, and/or notification/communication systems. For example, the consumer may receive an e-mail or text with a hyperlink to a web page at which the Consumer may review the available capacity, and perhaps make use of it—e.g., by booking an appointment in this example. Similarly, a particular Provider may receive an e-mail, text, or other alert (e.g., pop-up window or other message in a graphical user interface dashboard) indicating that there is demand matching the particular provider's expertise, etc., and provide the Provider with an option to approve/initiate scheduling of a visit/procedure, etc. in accordance with the demand. Data, such as provider identity, consumer identity, location, day/time, resource/task/procedure and/or other relevant information may be stored, by the RM 280/SE 270/CDSS 200 as Scheduling Data 224e, and may be communication to the Provider Computing Device, Consumer Computing Device or other systems as appropriate.

In some embodiments, the visit may be automatedly scheduled by the CDSS 200 (e.g., according to availability of the provider, open appointment slots, etc.), and optionally, in accordance with scheduling rules, e.g., scheduling rules provided by the Provider in the Provider's profile/account. In certain circumstances, the Payment Module 280 may receive/gather data for processing a payment and/or invoicing/processing an insurance claim, e.g., in accordance with the Provider's standard pricing schedule, applicable insurance schedules or otherwise as appropriate. Corresponding data may be stored by the PM 280 as Payment Data 224f in the data store 224.

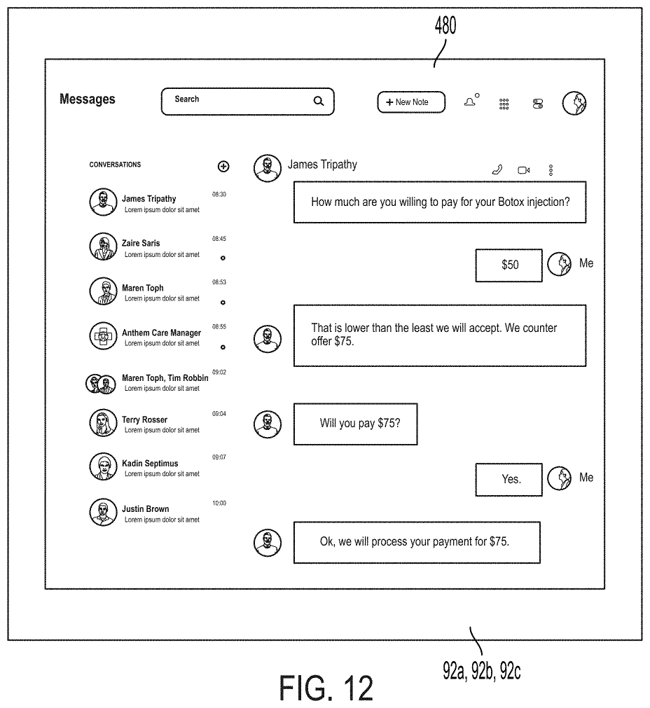

If, however, it is determined at 328, e.g. by the Payment Module, that the instance of the CDSS 200 system or the particular resource provider involved uses the system's Pricing Module, then a graphical user interface window may be displayed at a Consumer's Computing Device 92a, 92b, 92c for gathering a Consumer's offer for payment to the Provider, for the Resource, as shown at 332. By way of example, FIG. 12 shows an exemplary graphical user interface window 480 that may be caused to be displayed by the CDSS 200 at a Consumer Computing Device 92a, 92b, 92c. The exemplary window 480 is formatted as a messaging/chat-style interface, and is configured to deliver prompts to a Consumer to provide input indicating an amount offered for the resource, as will be appreciated from FIG. 12. Display of one or more windows for this purpose may be managed at least in part by the PM 280.

Referring again to FIG. 3A, the CDSS 200 receives and stores data relating to any such offer and any associated counteroffer, as shown at 334 in FIG. 3A. Receipt of such data, and storage of such data as Payment Data 224f in the Data Store 224 stored in the memory 218 of the CDSS 200 may be managed at least in part by the PM 280.

The PM 280 is responsible for effectively negotiating a price for the service. Accordingly, the PM 280 may accept the offer, compare the offer to predetermined limits, or apply any suitable logic to make counteroffers and/or accept offers, according to rules and/or other logic of the PM 280 and/or in conjunction with a Provider-specific information, which may be stored as Provider Data. In certain other embodiments, the PM 280 may compare the Consumer's offer to pre-established acceptable offers, or discounts, or pricing strategy, or ranges, and/or may provide counteroffers and/or negotiate the pricing in accordance with pre-determined parameters and/or logic, which may be gathered/selected from the Provider (or the Consumer) during the registration process (and be retrieved from the Provider Data 224a and/or the Consumer Data 224b, as appropriate).

The PM 280 the determines if the Consumer's payment offer is acceptable to the Provider, as shown at 336. If so, then method flow continues to 330, an appointment is scheduled as described above, and the method may end at 331.

If, however, the PM 280 determines that the Consumer's payment offer is not acceptable to the Provider at 336, then the system may be configured to permit the Provider to make a manual counteroffer (e.g., by entering data into a suitable graphical user interface window caused to be displayed to an operator of the Provider Computing Device 90a, 90b, or to make one or more automated counteroffers (e.g., according to predetermined rules, logic, limits, etc. stored as data).

If a Provider/the system does not make a counteroffer at 338, then the exemplary method ends at 331, without an appointment. If, however, the Provider/system does make a counteroffer at 338, then the PM 280 determines if the Provider's counteroffer is acceptable to the Consumer, as shown at 340. This may involve, for example, transmitting data for display of a graphical user interface window, such as window 480 of FIG. 12, with associated text prompts, and analyzing responses from the Consumer, e.g., using chatbot-type functionality. In the example of FIG. 12, the Consumer offered a $50 payment for a Botox injection, the Provider/system rejected that offer and counteroffered at $75, and the Consumer agreed to pay $75, as will be appreciated from FIG. 12.

If the counteroffer is determined by the Provider/system (PM 280) to not be acceptable, then the exemplary method ends at 331, without an appointment. If, however, the Provider/PM 280 determined that the counteroffer is acceptable, then method flow continues to 330, an appointment is scheduled as described above, and the method may end at 331.

Accordingly, it will be appreciated that the present invention provides a computerized system and method for providing a user interface and system for managing scheduling of tasks on a capacity-driven basis. Thus, the present invention provides a system that improves the efficiency of use of limited resources. Further, the system effectively reverses the typical balance of power and negotiation leverage, for example, in medical/healthcare provider and patient/consumer transactions. More particularly, it allows the provider the freedom to determine pricing, and perhaps apply premium pricing in a typical appointment-based scheduling scenarios, but also notifies patients/consumers of changes in capacity (e.g., due to appointment cancellations) that favor the patient/consumer, and present an opportunity for discounted pricing, while also allow the provider to avoid a lost revenue opportunity. For example, a Consumer/Patient's offer to pay $100 for a procedure typically costing $300 may be an attractive offer to the Provider, since otherwise, the newly-available capacity (resulting from an appointment cancellation) may be lost as no substitute appointment may be scheduled on short notice, and thus, the value of that capacity may otherwise by $0, making $100 an attractive alternative, even though less than the typical $300. This information may be stored as Payment Data 224f in the Data Store 224 of the CDSS 200, e.g., as an “offer.” Notable, the system is structured as a system serving multiple providers, so that consumer demand and provider capacity may be matched across multiple providers, which is atypical in particular for medical/healthcare providers. This provides an increased opportunity for discounted services to the consumer/patient, and provides increased revenue opportunities across the multiple providers as lost revenue opportunities are decreased.

The various implementations and examples shown above illustrate a method and system for preforming a patient clinical assessment using an electronic device. As is evident from the foregoing description, certain aspects of the present implementation are not limited by the particular details of the examples illustrated herein, and it is therefore contemplated that other modifications and applications, or equivalents thereof, will occur to those skilled in the art. It is accordingly intended that the claims shall cover all such modifications and applications that do not depart from the spirit and scope of the present implementation. Accordingly, the specification and drawings are to be regarded in an illustrative rather than a restrictive sense.

Certain systems, apparatus, applications or processes are described herein as including a number of modules. A module may be a unit of distinct functionality that may be presented in software, hardware, or combinations thereof.

When the functionality of a module is performed in any part through software, the module includes a computer-readable medium. The modules may be regarded as being communicatively coupled. The inventive subject matter may be represented in a variety of different implementations of which there are many possible permutations.

The methods described herein do not have to be executed in the order described, or in any particular order. Moreover, various activities described with respect to the methods identified herein can be executed in serial or parallel fashion. In the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separate embodiment.

In an exemplary embodiment, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a smart phone, a web appliance, a network router, switch or bridge, or any machine capable of executing a set of instructions (sequential or otherwise) that specify actions to be taken by that machine or computing device. Further, while only a single machine is illustrated, the term “machine” shall also be taken to include any collection of machines that individually or jointly execute a set (or multiple sets) of instructions to perform any one or more of the methodologies discussed herein.

The example computer system and client computers include a processor (e.g., a central processing unit (CPU) a graphics processing unit (GPU) or both), a main memory and a static memory, which communicate with each other via a bus. The computer system may further include a video/graphical display unit (e.g., a liquid crystal display (LCD) or a cathode ray tube (CRT)). The computer system and client computing devices also include an alphanumeric input device (e.g., a keyboard or touch-screen), a cursor control device (e.g., a mouse or gestures on a touch-screen), a drive unit, a signal generation device (e.g., a speaker and microphone) and a network interface device.

The system may include a computer-readable medium on which is stored one or more sets of instructions (e.g., software) embodying any one or more of the methodologies or systems described herein. The software may also reside, completely or at least partially, within the main memory and/or within the processor during execution thereof by the computer system, the main memory and the processor also constituting computer-readable media. The software may further be transmitted or received over a network via the network interface device.

The term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing or encoding a set of instructions for execution by the machine and that cause the machine to perform any one or more of the methodologies of the present implementation. The term “computer-readable medium” shall accordingly be taken to include, but not be limited to, solid-state memories, and optical media, and magnetic media.

The present invention may be operational with numerous other general-purpose or special-purpose computing system environments or configurations. Examples of well-known computing systems, environments, and/or configurations that may be suitable for use with the present invention include, by way of example only, personal computers, server computers, hand-held or laptop devices, multiprocessor systems, microprocessor-based systems, set top boxes, programmable consumer electronics, cellular telephones, network PCs, minicomputers, mainframe computers, distributed computing environments that include any of the above-mentioned systems or devices, and the like.

The present invention has been described in the general context of computer-executable instructions, such as program modules or engines, being executed by a computer. Generally, program modules include, but are not limited to, routines, programs, objects, components, and data structures that perform particular tasks or implement particular abstract data types. The present invention may also be practiced in distributed computing environments where tasks are performed by remote processing devices that are linked through a communications network. In a distributed computing environment, program modules/engines may be located in local and/or remote computer-storage media including, by way of example only, memory storage devices.

The exemplary computing system may include general-purpose computing hardware in the form of a server. Components of the server may include, without limitation, a processing unit, internal system memory, and a suitable system bus for coupling various system components, including a database cluster, with the server. The system bus may be any of several types of bus structures, including a memory bus or memory controller, a peripheral bus, and a local bus, using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

The server typically includes therein, or has access to, a variety of computer-readable media, for instance, via a database cluster. Computer-readable media can be any available media that may be accessed by the server, and includes volatile and nonvolatile media, as well as removable and non-removable media. By way of example, and not limitation, computer-readable media may include computer-storage media and communication media. Computer-storage media may include, without limitation, volatile and nonvolatile media, as well as removable and non-removable media implemented in any method or technology for storage of information, such as computer readable instructions, data structures, program modules, or other data. In this regard, computer-storage media may include, but is not limited to, RAM, ROM, EEPROM, flash memory or other memory technology, CD-ROM, digital versatile disks (DVDs) or other optical disk storage, magnetic cassettes, magnetic tape, magnetic disk storage, or other magnetic storage device, or any other medium which can be used to store the desired information, and which may be accessed by the server. Communication media typically embodies computer readable instructions, data structures, program modules, or other data in a modulated data signal, such as a carrier wave or other transport mechanism, and may include any information delivery media. The term “modulated data signal” refers to a signal that has one or more of its attributes set or changed in such a manner as to encode information in the signal. By way of example, and not limitation, communication media includes wired media such as a wired network or direct-wired connection, and wireless media such as acoustic, RF, infrared, and other wireless media. Combinations of any of the above also may be included within the scope of computer-readable media.

The server may operate in a computer network using logical connections to one or more remote computers. Remote computers may be located at a variety of locations or over the Internet. The remote computers may be personal computers, servers, routers, network PCs, peer devices, other common network nodes, or the like, and may include some or all of the elements described above in relation to the server. The computing devices can be personal digital assistants or other like devices.

Exemplary computer networks may include, without limitation, local area networks (LANs) and/or wide area networks (WANs). Such networking environments are commonplace in offices, enterprise-wide computer networks, intranets, and the Internet. When utilized in a WAN networking environment, the server may include a modem/network card or other means for establishing communications over the WAN, such as the Internet. In a networked environment, program modules or portions thereof may be stored in the server, in the database cluster, or on any of the remote computers. For example, and not by way of limitation, various application programs may reside on the memory associated with any one or more of the remote computers. It will be appreciated by those of ordinary skill in the art that the network connections shown are exemplary and other means of establishing a communications link between the computers (e.g., the server and remote computers) may be utilized.

In operation, a user may enter commands and information into the server or convey the commands and information to the server via one or more of the remote computers through input devices, such as a keyboard, a pointing device (commonly referred to as a mouse), a trackball, or a touch pad. Other input devices may include, without limitation, microphones, satellite dishes, scanners, or the like. Commands and information may also be sent directly from a remote device to the server. In addition to a monitor, the server and/or remote computers may include other peripheral output devices, such as speakers and a printer.

Many other internal components of the server and the remote computers/computing devices are not shown because such components and their interconnection are well known. Accordingly, additional details concerning the internal construction of the server and the remote computers/computing devices are not further disclosed herein.

Although methods and systems of embodiments of the present invention may be implemented in a WINDOWS or LINUX operating system, operating in conjunction with an Internet-based delivery system, one of ordinary skill in the art will recognize that the described methods and systems can be implemented in any system supporting the functionality described herein. As contemplated by the language above, the methods and systems of embodiments of the present invention may also be implemented on a stand-alone desktop, personal computer, cellular phone, smart phone, tablet, PDA, or any other computing device used in various locations.

Additionally, computer readable media storing computer readable code for carrying out the method steps identified above is provided. The computer readable media stores code for carrying out subprocesses for carrying out the methods described herein.

A computer program product recorded on a computer readable medium for carrying out the method steps identified herein is provided. The computer program product comprises computer readable means for carrying out the methods described above.

While there have been described herein the principles of the invention, it is to be understood by those skilled in the art that this description is made only by way of example and not as a limitation to the scope of the invention. Accordingly, it is intended by the appended claims, to cover all modifications of the invention which fall within the true spirit and scope of the invention.

What is claimed is:

1. A capacity driven scheduling system comprising:
a memory operatively comprising a non-transitory data processor-readable medium;
a data processor operatively connected to the memory, the display device and the user input device;
user interface management instructions embodied in data processor-executable code stored in the memory, said user interface management instructions being executable by the data processor to provide a user interface display engine configured to:
cause display at a provider computing device of a graphical user interface window requesting input of provider information relating to resources that may be provided by the provider;
cause display at the consumer computing device of a graphical user interface window requesting input of resource desire information;
monitor for a change in a capacity for each of a plurality of providers to provide resources; and
in response to identification of a particular unit of capacity for a particular provider, identify a consumer having resource desire information matching the particular unit of capacity for the particular provider; and
schedule an appointment for the provider with the consumer having with the resource desire information matching the particular unit of capacity.

2. The system of claim 1, wherein said user interface management instructions causing display at a provider computing device of a graphical user interface window requests input of provider information identifying criteria for scheduling an appointment to treat a patient.

3. The system of claim 1, wherein said user interface management instructions causing display at a consumer computing device of a graphical user interface window requests input of consumer information identifying parameters associated with treatment of the consumer as a patient.

4. The system of claim 1, wherein said user interface management instructions further comprise instructions executable to configure the user interface display engine to:
cause display at the provider computing device of a graphical user interface window requesting input of resource capacity information.

5. The system of claim 1, wherein said user interface management instructions further comprise instructions executable to configure the user interface display engine to:
cause display at a consumer computing device of a graphical user interface window requesting input of consumer information relating to purchase of resources by the consumer.

6. The system of claim 5, wherein said consumer information comprises at least one of a name, a location, an address, contact information, a preferred physician, a preferred specialty, a preferred procedure, an applicable insurance provider, a preference for house call availability.

7. The system of claim 1, wherein said provider information comprises at least one of a practice name, a practice location, a practice address, practice contact information, a physician name, a specialty name, an available procedure, an insurance accepted, procedure pricing, and an indication of availability for house calls.

8. The system of claim 1, wherein said user interface management instructions executable to configure the user interface display engine to cause display at the consumer computing device of a graphical user interface window requesting input of resource desire information comprises instructions to provide input comprising at least one of a name of a desired resource, a date on which that resource is desired, a timeframe in which that resource is desired, and an indication of whether need is a standing order.

9. The system of claim 1, wherein said user interface management instructions executable to configure the user interface display engine to, in response to identification of a particular unit of capacity for a particular provider, identify a consumer having resource desire information matching the particular unit of capacity for the particular provider are configured to cause display at a provider computing device of a graphical user interface window requesting input of provider capacity.

10. The system of claim 1, wherein said user interface management instructions executable to configure the user interface display engine to, in response to identification of a particular unit of capacity for a particular provider, identify a consumer having resource desire information matching the particular unit of capacity for the particular provider are configured to gather data identifying provider capacity by data exchange with an external computing system.

11. The system of claim 1, wherein said user interface management instructions executable to configure the user interface display engine to monitor for a change in a capacity for each of a plurality of providers to provide resources are configured to perform such monitoring for one of available capacity on an ongoing basis, available capacity resulting from canceled appointment and available capacity resulting from newly-added provider availability.

12. The system of claim 1, wherein said user interface management instructions executable to configure the user interface display engine to monitor for a change in a capacity for each of a plurality of providers to provide resources are configured to perform such monitoring for one of affiliated providers and unaffiliated providers.

13. The system of claim 1, wherein said user interface management instructions executable further comprise instructions executable by the data processor to configured the user interface display engine to, in response to identification of a particular provider having a particular available capacity for providing resources:
reference stored provider information for the particular provider to identify particular resources that may be provided by the particular resource provider;
reference stored provider information for the particular provider to identify additional information relating to a nature of the available capacity in support of the capacity-driven scheduling functionality described herein; and
reference stored resources desired information to identify at least one consumer desiring a resource that can be provided by the particular provider;
reference stored consumer information to determine whether said at least one consumer has additional parameters compatible with the provider information;
compares the stored provider information and consumer information to determine compatibility; and
transmits data to cause scheduling of an appointment for the provider to provide the desired resource to the consumer.

14. The system of claim 13, wherein said additional parameters are selected from a group consisting of a practice name, a physician specialty, an insurance accepted, a resource name, a medical procedure name, a location name, a proximity requirement, and an availability timeframe.

15. The system of claim 13, further comprising one of transmitting data to update scheduling software of one of a provider and a consumer.

16. The system of claim 13, further comprising processing one of a payment and an insurance claim for payment for the resource.

17. The system of claim 13, wherein said user interface management instructions executable further comprise instructions executable by the data processor are configured to transmit data to cause display to a consumer of a graphical user interface window for gathering the consumer's offer for payment of the resource.

18. The system of claim 13, wherein said user interface management instructions executable further comprise instructions executable by the data processor are configured to transmit data for display of a graphical user interface window for automatedly negotiating a payment amount for the resource.

19. A computer-implemented method of controlling a display of a computerized device to provide capacity-driven scheduling, the computerized device comprising a memory operatively comprising a non-transitory data processor-readable medium, a data processor operative connected to the memory, the display and the user input component, and user interface management instructions embodied in data processor-executable code stored in the memory and executable by the data processor, the method comprising:
causing display at a provider computing device of a graphical user interface window requesting input of provider information, the provider information identifying criteria for scheduling an appointment to treat a patient;
causing display at a consumer computing device of a graphical user interface window requesting input of consider information, the consumer information identifying parameters associated with treatment of the consumer as a patient;
causing display at the provider computing device of a graphical user interface window requesting input of resource capacity information;
causing display at the consumer computing device of a graphical user interface window requesting input of resource desire information;
monitor for changes in capacity for each of a plurality of providers; and
in response to identification of a particular unit of capacity for a particular provider, identifying a consumer having resource desire information matching the particular unit of capacity; and
scheduling an appointment for the provider with the consumer having with the resource desire information matching the particular unit of capacity.

20. A computer program product for implementing a method of controlling a display of a computerized device, the computer program product comprising a non-transitory computer-readable medium storing executable instructions that, when executed by a processor, cause a computerized capacity driven schedule system to perform a method comprising:
causing display at a provider computing device of a graphical user interface window requesting input of provider information, the provider information identifying criteria for scheduling an appointment to treat a patient;
causing display at a consumer computing device of a graphical user interface window requesting input of consider information, the consumer information identifying parameters associated with treatment of the consumer as a patient;
causing display at the provider computing device of a graphical user interface window requesting input of resource capacity information;
causing display at the consumer computing device of a graphical user interface window requesting input of resource desire information;
monitor for changes in capacity for each of a plurality of providers; and
in response to identification of a particular unit of capacity for a particular provider, identifying a consumer having resource desire information matching the particular unit of capacity; and
scheduling an appointment for the provider with the consumer having with the resource desire information matching the particular unit of capacity.
